(19) United States
(12) Patent Application Publication
(10) Pub. No.: US 2013/0268555 A1
(43) Pub. Date: Oct. 10, 2013

(54) MEDICAL INFORMATION SEARCH APPARATUS

(71) Applicants: KABUSHIKI KAISHA TOSHIBA, Tokyo (JP); TOSHIBA MEDICAL SYSTEMS CORPORATION, Otawara-Shi (JP)

(72) Inventor: Kazuki UTSUNOMIYA, Otawara-Shi (JP)

(73) Assignees: Toshiba Medical Systems Corporation, Otawara-Shi (JP); KABUSHIKI KAISHA TOSHIBA, Tokyo (JP)

(21) Appl. No.: 13/856,697

(22) Filed: Apr. 4, 2013

(30) Foreign Application Priority Data
Apr. 6, 2012 (JP) 2012-087815

(51) Int. Cl. G06F 17/30

(52) U.S. Cl. CPC G06F 17/30244
USPC 707/769

(57) ABSTRACT

According to one embodiment, a medical information search apparatus includes a registration unit, a search condition acquisition unit, and a search unit. The registration unit is configured to register, in a management server, at least medical information and information of a schema template included in the medical information associated with each other. The search condition acquisition unit is configured to acquire information of the schema template based on a search condition set by a user through an input unit. The search unit is configured to retrieve, from the management server, medical information associated with information of the schema template acquired by the search condition acquisition unit.

### CROSS-REFERENCE TO RELATED APPLICATIONS

This application claims the benefit of priority of Japanese Patent Application No. 2012-87815, filed Apr. 6, 2012, the entire contents of which are incorporated herein by reference.

### FIELD

Embodiments described herein relate generally to a medical information search apparatus.

### BACKGROUND

Recent years have seen a widespread use of a technique for managing medical treatment information by means of computerized medical information including electronic medical records (EMRs). In general, the medical information includes patient information such as patient names and patient's medical treatment information registered associated with each other.

The medical treatment information in the electronic medical records includes text information such as findings according to pathological conditions and image information such as schema diagrams. For example, if the patient is a returning patient, use of electronic medical records make it easy to extract electronic medical records in the past by text search. Thus, a doctor can easily and quickly display desired electronic medical records on a display unit of a terminal used by the doctor.

However, the text information registered in the electronic medical records may be different in expression depending on the doctor even if symptoms and findings are the same. For example, the text information registered related to a lung cancer may include different expressions depending on the doctor such as “a lung cancer in the right lung”, “a shadow in the lung”, and “a cancer in the lung”.

Here, if a keyword search is made to extract electronic medical records with a keyword “lung cancer”, the electronic medical records including “a lung cancer in the right lung” are extracted, but the electronic medical records including “a shadow in the lung” or “a cancer in the lung” are not extracted. For this reason, for example, in order to refer to similar cases in the past, the user has to attempt to search several times with various keywords to compensate for different expressions in the text information registered in the electronic medical records until the desired electronic medical records are extracted, which is very inconvenient.

Further, in fact, there is medical information registered including no text information but only schema diagrams. This kind of medical information cannot be retrieved with a keyword.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is an entire configuration view illustrating an example of an electronic medical record search support system 10 according to a first embodiment of the present invention;

FIG. 2 is an explanatory drawing illustrating an example of a schema template table stored in the storage unit;

FIG. 3 is an explanatory drawing illustrating an example of a keyword schema association table stored in the storage unit;

FIG. 4 is an explanatory drawing illustrating an example of an electronic medical record image according to the first embodiment;

FIG. 5 is an explanatory drawing illustrating a configuration example of electronic medical record data managed by the medical record management server;

FIG. 6 is an explanatory drawing illustrating an example of an electronic medical record search image according to the first embodiment;

FIG. 7 is an explanatory drawing illustrating an example of an electronic medical record search result image according to the first embodiment;

FIG. 8 is a flowchart illustrating a procedure for registering data associating information of at least an electronic medical record with information of a schema template included in the electronic medical record in the medical record management server by means of the CPU of the control unit according to the first embodiment;

FIG. 9 is a flowchart illustrating a procedure for retrieving the electronic medical record based on the schema template used in the electronic medical record by means of the CPU of the control unit according to the first embodiment;

FIG. 10 is an entire configuration view illustrating an example of an electronic medical record search support system according to the second embodiment of the present invention;

FIG. 11 is an explanatory drawing illustrating an example of an electronic medical record image according to the second embodiment;

FIG. 12 is an explanatory drawing illustrating an example of an electronic medical record search image according to the second embodiment;

FIG. 13 is an explanatory drawing illustrating an example of an electronic medical record search result image according to the second embodiment;

FIG. 14 is a flowchart illustrating a procedure for registering data associating information of at least an electronic medical record, information of a schema template included in the electronic medical record, and information of set region of interest 51 with each other in the medical record management server by means of the CPU of the control unit according to the second embodiment;

FIG. 15 is a flowchart illustrating a procedure for retrieving the electronic medical record based on the region of interest of the schema template by means of the CPU of the control unit according to the second embodiment;

FIG. 16 is an entire configuration view illustrating an example of an electronic medical record search support system according to the third embodiment of the present invention; and

FIG. 17 is a flowchart illustrating a procedure for retrieving an electronic medical record based on information of the schema template used in the electronic medical record and information of the region of interest of the schema template by means of the CPU of the control unit according to the third embodiment.

### DETAILED DESCRIPTION

Hereinbelow, a description will be given of a medical information search apparatus according to embodiments of the present invention with reference to the drawings.

In general, according to one embodiment, a medical information search apparatus includes a registration unit, a search condition acquisition unit, and a search unit. The registration unit is configured to register, in a management server, at least medical information and information of a schema template included in the medical information associated with each other. The search condition acquisition unit is configured to acquire information of the schema template based on a search condition set by a user through an input unit. The search unit is configured to retrieve, from the management server, medical information associated with information of the schema template acquired by the search condition acquisition unit.

The medical information to be retrieved by the medical information search apparatus may be electronic medical records including findings of doctors or for example, may be medical information including only medical images and schema diagrams associated with each other. Note that the following description will focus on an example of using an electronic medical record search support device for supporting electronic medical record search and retrieval as the medical information search apparatus according to the present invention.

### First Embodiment

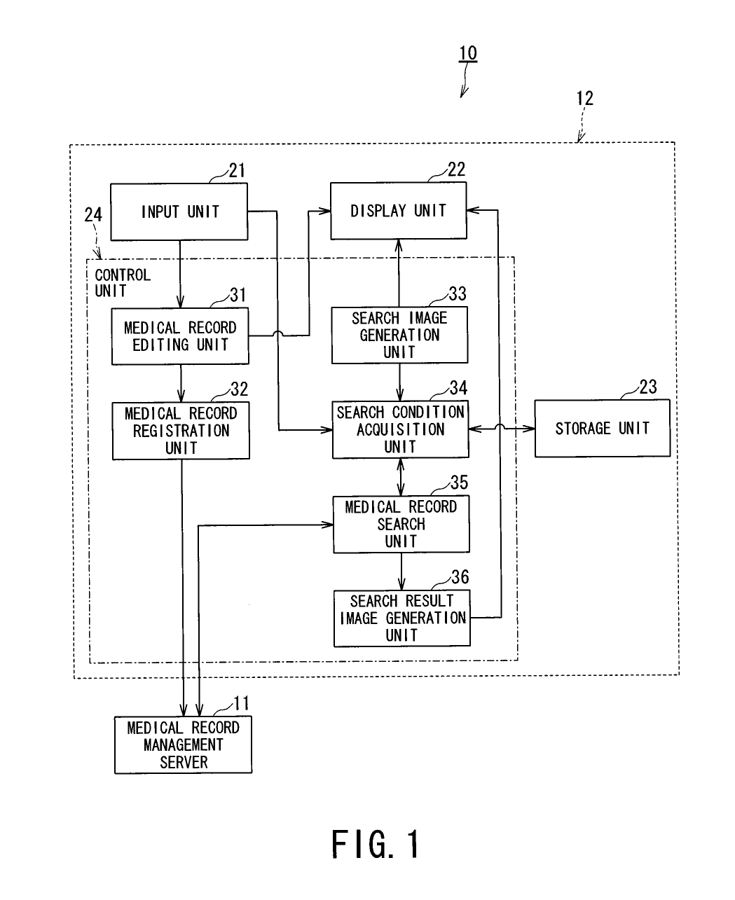

FIG. 1 is an entire configuration view illustrating an example of an electronic medical record search support system 10 according to a first embodiment of the present invention. The electronic medical record search support system 10 according to the first embodiment performs electronic medical record search and retrieval based on information of at least a schema template associated with an input keyword for search.

The electronic medical record search support system 10 includes a medical record management server 11 and an electronic medical record search support device 12 wiredly or wirelessly connected in a data transmittable and receivable manner to the medical record management server 11 as a medical information search apparatus. The medical record management server 11 may be connected to the electronic medical record search support device 12 via a network. The network refers to a general information communication network using telecommunications technology and includes not only a wireless/wired LAN and the Internet network such as a hospital backbone local area network (LAN), but also a telephone communication network, an optical fiber communication network, a cable communication network, a satellite communication network, and other networks.

The medical record management server 11 manages medical information such as EMRs as a database. The medical information includes any one of medical images acquired by various modalities, information of the schema template, and doctor's findings, or a plurality thereof selected therefrom. The following description will focus on an example in which the medical record management server 11 manages, as a database, the electronic medical records registered by the electronic medical record search support device 12. The electronic medical record search support device 12 searches the database in the medical record management server 11 for the required electronic medical records.

The electronic medical record search support device 12 includes an input unit 21, a display unit 22, a storage unit 23, and a control unit 24.

For example, the input unit 21 includes common input devices such as a keyboard, a touch panel, and a numeric keypad to output an operation input signal corresponding to a user operation to the control unit 24.

For example, the display unit 22 includes common display output devices such as a liquid crystal display and an organic light emitting diode (OLED) display to display various types of information such as search images and search result images under control of the control unit 24.

The storage unit 23 is a data rewritable nonvolatile memory, and for example, can be made of a hard disk drive or a solid-state drive.

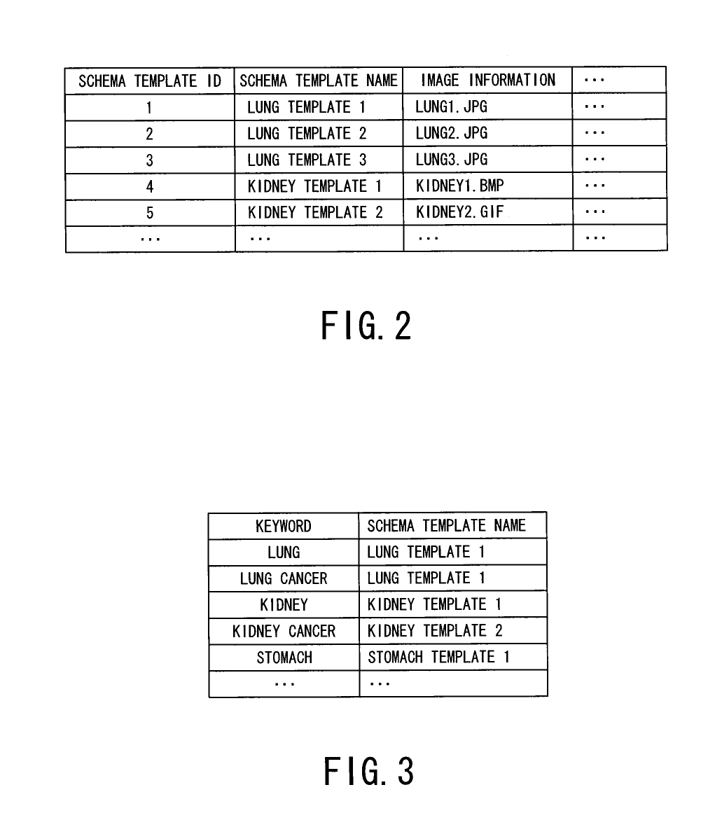

FIG. 2 is an explanatory drawing illustrating an example of a schema template table stored in the storage unit 23. FIG. 3 is an explanatory drawing illustrating an example of a keyword schema association table stored in the storage unit 23.

The storage unit 23 stores a schema template table preliminarily associating a schema template ID, a schema template name, schema template image information, and other information for each schema template (see FIG. 2). Here, information of the schema template refers to at least one of the schema template ID, the schema template name, and the schema template image information. Note that the information of the schema template may be information for identifying a schema template and for example, may be a type of a schema template.

In addition, the storage unit 23 stores a keyword schema association table preliminarily associating a keyword with information of the schema template (see FIG. 3). FIG. 3 illustrates an example of using a schema template name as the information of the schema template for use in the keyword schema association table. The keyword may include at least one of an organ name and a disease name.

Note that a part or all of data such as a schema template table and a keyword schema association table preliminarily stored in the storage unit 23 may be downloaded and updated through a network as needed.

The control unit 24 includes storage media such as a CPU, a RAM, and a ROM to control the operation of the electronic medical record search support device 12 according to programs stored in the storage media. The CPU of the control unit 24 loads, to the RAM, an electronic medical record search support program stored in the storage media such as the ROM and data required to execute the program so as to execute a process for supporting search and retrieval of electronic medical records desired by the user according to the program even if the text information registered in the electronic medical records varies in expression or the text information is not registered in the electronic medical records.

The RAM of the control unit 24 provides a work area for temporarily storing the program to be executed by the CPU and the data. The storage media such as the ROM of the control unit 24 store a boot program for the electronic medical record search support device 12, the electronic medical record search support program, and various data required to execute those programs.

Note that the storage media such as the ROM are configured to include a CPU-readable recording medium such as a magnetic or optical recording medium or a semiconductor memory, and a part or all of the programs and data stored in the storage media may be configured to be downloaded through a network.

As illustrated in FIG. 1, the CPU of the control unit 24 functions as at least a medical record editing unit 31, a medical record registration unit 32, a search image generation unit 33, a search condition acquisition unit 34, a medical record search unit 35, and a search result image generation unit 36 by means of the electronic medical record search support program. Each of the units 31 to 36 uses a work area required for the RAM as a temporary data storage place. Note that the function implementing units may be configured not by the CPU but by hardware logic such as a circuit.

First, a configuration related to an electronic medical record registration according to the first embodiment will be described.

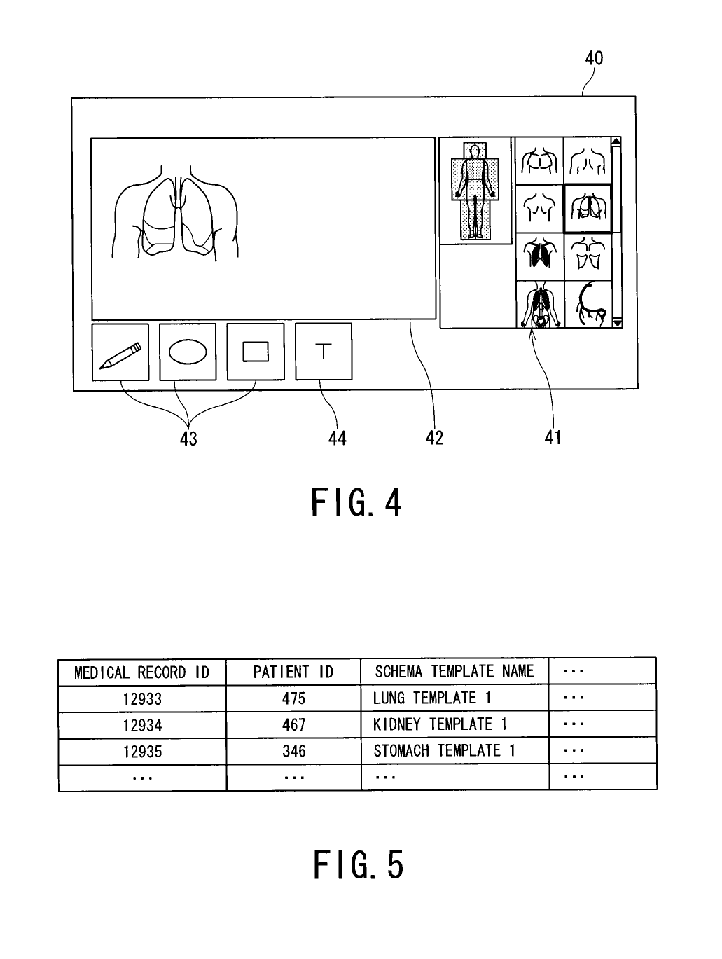

FIG. 4 is an explanatory drawing illustrating an example of an electronic medical record image 40 according to the first embodiment.

When a request to edit a predetermined electronic medical record is received from a user through the input unit 21, the medical record editing unit 31 displays an electronic medical record image 40 whose content is information of the electronic medical record on the display unit 22.

The electronic medical record image 40 includes a first region 41 for displaying an image calling a schema template and a second region 42 not only for displaying an image of the called schema template but also for receiving an edit to the schema template image by the user through the input unit 21.

The electronic medical record image 40 further includes a drawing tool 43 to be used by the user to edit the schema template image displayed in the second region 42 and a text input tool 44 to be used by the user to enter text information such as pathological conditions and findings into the electronic medical record.

The medical record editing unit 31 receives a selection of the schema template in response to a user operation to the schema template calling image in the first region 41. As a result, the electronic medical record will include the image of the selected schema template. The medical record editing unit 31 further receives a text information input to the electronic medical record. Note that in the present embodiment, text information may not be inputted to the electronic medical record.

FIG. 5 is an explanatory drawing illustrating a configuration example of electronic medical record data managed by the medical record management server 11.

The medical record registration unit 32 acquires, from the medical record editing unit 31, information of at least an electronic medical record currently subject to editing and information of a schema template included in the electronic medical record. Then, when an instruction to register (save) the electronic medical record is received from the user through the input unit 21, the medical record registration unit 32 registers, in the medical record management server 11, information of at least the electronic medical record and information of the schema template included in the electronic medical record associated with each other.

FIG. 5 illustrates an example in which electronic medical record data managed by the medical record management server 11 is data associating at least an electronic medical record ID, a patient ID, and a schema template name with each other.

As a result, the medical record management server 11 maintains a database associating information of at least the electronic medical record with information of the schema template included in the electronic medical record.

Secondly, a configuration related to an electronic medical record search and retrieval according to the first embodiment will be described.

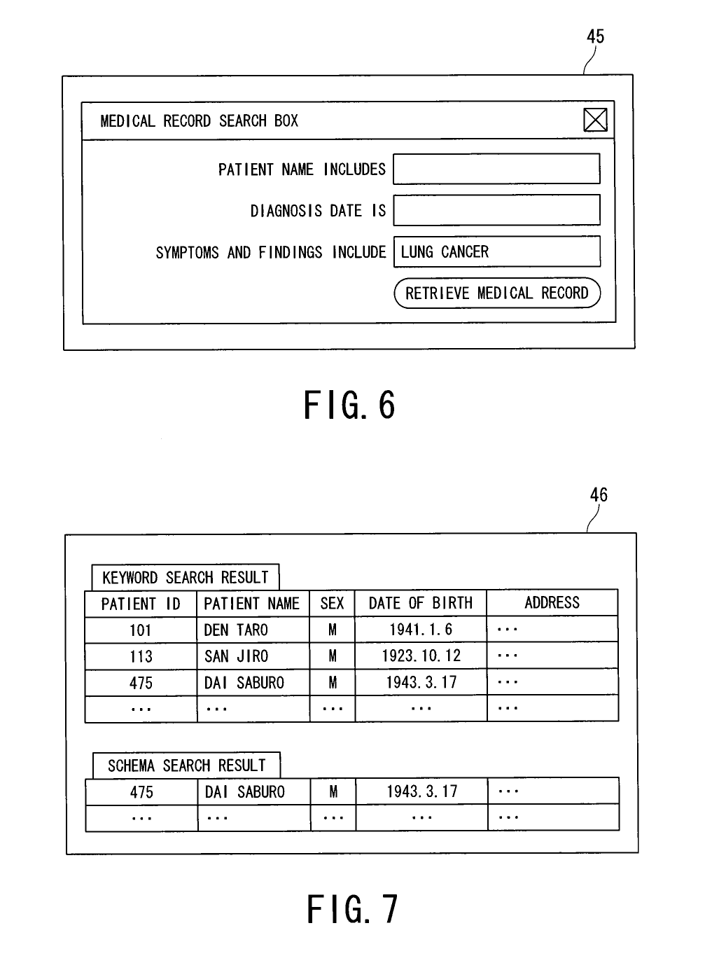

FIG. 6 is an explanatory drawing illustrating an example of an electronic medical record search image 45 according to the first embodiment.

When a search start request of an electronic medical record is received from a user through the input unit 21, the search image generation unit 33 displays a search condition setting image (search image) 45 for receiving an input of electronic medical record search conditions on the display unit 22 (see FIG. 6). The user uses the search image 45 to input search conditions through the input unit 21. The present embodiment will describe an example in which a search condition inputted by the user is at least a keyword (character string) in the keyword schema association table stored in the storage unit 23.

The search condition acquisition unit 34 acquires information of the keyword (input keyword) inputted by the user and acquires information of the schema template associated with the input keyword from the keyword schema association table (see FIG. 3) in the storage unit 23. The input keyword includes at least a keyword in the keyword schema association table and may further include a keyword indicating a patient name, a diagnosis date and others.

For example, if the input keyword is “lung cancer”, the search condition acquisition unit 34 acquires “lung template 1” in the schema template name as illustrated in FIG. 3. Once a schema template name is acquired, information other than schema template name (schema template ID or the like) can be used for searching based on the schema template table (see FIG. 2) stored in the storage unit 23.

The medical record search unit 35 searches the medical record management server 11 based on the information of at least the schema template acquired by the search condition acquisition unit 34. The following description will focus on an example in which the medical record search unit 35 searches the medical record management server 11 based on information of the input keyword and information of the schema template. Note that when the information of the input keyword itself is used for search, the medical record search unit 35 may perform an OR search or an AND search using the information of the input keyword and the information of the schema template.

The search method using the information of the input keyword itself includes a method of retrieving an electronic medical record associated with text information corresponding to the input keyword such as the same text information as the input keyword and text information including the input keyword of the text information of the electronic medical records registered in the medical record management server 11.

FIG. 7 is an explanatory drawing illustrating an example of an electronic medical record search result image 46 according to the first embodiment.

The search result image generation unit 36 generates a search result image 46 based on the search result by the medical record search unit 35 so as to be displayed on the display unit 22. FIG. 7 illustrates an example in which the search result image 46 includes a keyword search result based on an input keyword and a schema search result based on information of the schema template. Note that for example, when the medical record search unit 35 searches using the information of the input keyword itself, the search result image generation unit 36 may generate an OR search result image using the information of the input keyword and the information of the schema template as illustrated in FIG. 7 or may generate an AND search result image using the same.

Now, an example of operation of the electronic medical record search support system 10 according to the present embodiment will be described.

First, an electronic medical record registration process according to the first embodiment will be described.

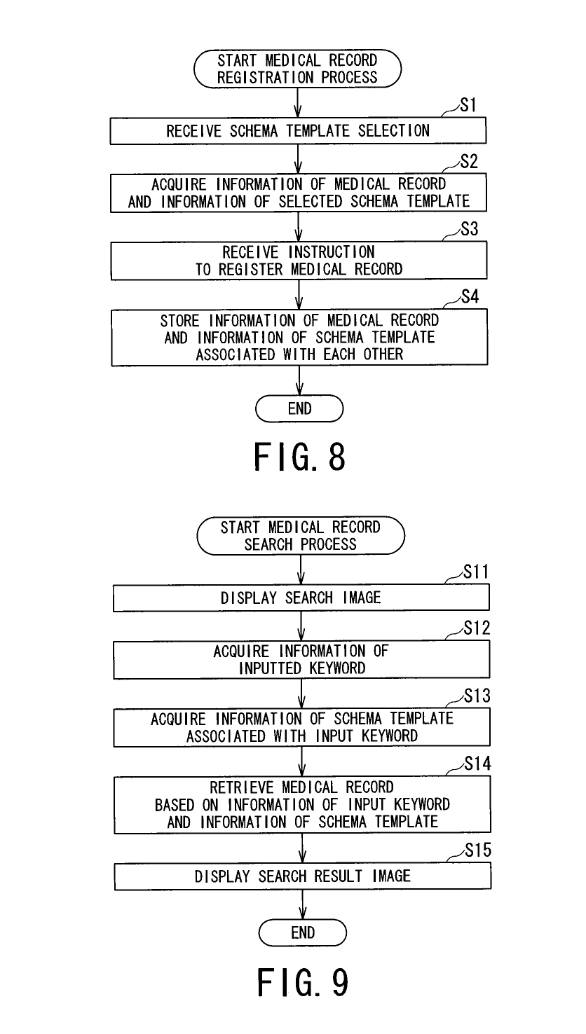

FIG. 8 is a flowchart illustrating a procedure for registering data associating information of at least an electronic medical record with information of a schema template included in the electronic medical record in the medical record management server 11 by means of the CPU of the control unit 24 according to the first embodiment. In FIG. 8, a reference character with “S” followed by a number such as “S1” denotes each step of the flowchart.

The procedure starts at a time when a request to edit a predetermined electronic medical record is received from a user through the input unit 21 and an electronic medical record image 40 whose content is information of the electronic medical record is displayed on the display unit 22.

First in step S1, the medical record editing unit 31 receives a selection of a schema template according to a user operation to a schema template calling image in the first region 41.

Then in step S2, the medical record registration unit 32 acquires, from the medical record editing unit 31, information of at least an electronic medical record currently subject to editing and information of the selected schema template included in the electronic medical record.

Then in step S3, the medical record registration unit 32 receives an instruction to register (save) the electronic medical record from the user through the input unit 21.

Then in step S4, the medical record registration unit 32 registers, in the medical record management server 11, information of at least the electronic medical record and information of the schema template included in the electronic medical record associated with each other.

The aforementioned procedure makes it possible to register, in the medical record management server 11, data associating information of at least the electronic medical record and information of the schema template included in the electronic medical record with each other (see FIG. 5).

Now, an operation of an electronic medical record search and retrieval according to the first embodiment will be described.

FIG. 9 is a flowchart illustrating a procedure for retrieving the electronic medical record based on the schema template used in the electronic medical record by means of the CPU of the control unit 24 according to the first embodiment. In FIG. 9, a reference character with “S” followed by a number such as “S11” denotes each step of the flowchart.

First in step S11, the search image generation unit 33 displays a search image 45 for receiving an input of a search condition for the electronic medical record on the display unit 22 (see FIG. 6).

Then in step S12, the search condition acquisition unit 34 acquires information of a keyword inputted by the user. The input keyword includes at least a keyword in the keyword schema association table and may further include a keyword indicating a patient name, a diagnosis date and others.

Then in step S13, the search condition acquisition unit 34 acquires information of the schema template associated with the input keyword from the keyword schema association table (see FIG. 3) in the storage unit 23.

Then in step S14, the medical record search unit 35 searches the medical record management server 11 based on information of at least the schema template acquired by the search condition acquisition unit 34. At the same time, the medical record search unit 35 may also search based on information of the input keyword.

Then in step S15, the search result image generation unit 36 generates a search result image 46 based on the search result of the medical record search unit 35 so as to be displayed on the display unit 22 (see FIG. 7).

The aforementioned procedure makes it possible to retrieve the electronic medical record based on the schema template used in the electronic medical record.

The electronic medical record search support system 10 according to the present embodiment uses information of a schema template associated with an input keyword for search to retrieve the electronic medical record, and thereby can support the user in retrieving a desired electronic medical record even if the text information registered in the electronic medical record varies in expression or the text information is not registered in the electronic medical record. Thus, the electronic medical record search support system 10 allows the user to easily and accurately retrieve similar cases in the past.

For example, if the input keyword is “lung cancer”, the input keyword-based search cannot extract an electronic medical record including text information such as “lung”, “shadow in the lung”, “shadow in the right lung”, “shadow in the middle lobe of the lung”, and “shadow in the middle of the right lung” since the text information is not the “lung cancer” itself though the text information is related to the lung cancer.

Meanwhile, a search based on “lung template 1” of the schema template name associated with the input keyword “lung cancer” in the keyword schema association table extracts an electronic medical record including the “lung template 1”. Thus, the electronic medical record search support system 10 according to the present embodiment can extract all electronic medical records including the “lung template 1” even if the text information registered in the electronic medical records varies in expression or the text information is not registered in the electronic medical records.

Note that the schema template-based search may retrieve an electronic medical record that does not meet the user's desire. For example, when patients with suspected lung cancer are retrieved, the schema template-based search with an input of “lung cancer” as the input keyword may retrieve all electronic medical records associated with the “lung template 1”. The search results may include electronic medical records related to, for example, pneumonia patients.

In view of this, the search results may be narrowed by using the input keyword to set a predetermined exclusion criterion. In this case, the keyword schema association table further associated with the exclusion criterion is preliminarily stored in the storage unit 23. For example, an exclusion criterion “antibiotic administration” is further associated with the keyword “lung cancer” and the “lung template 1”.

Before searching, first, the search condition acquisition unit 34 acquires information of the schema template and information of the exclusion criterion based on the input keyword. Then, the medical record search unit 35 searches the medical record management server 11 by excluding the electronic medical records associated with the acquired exclusion criterion from the search object. As a result, in the aforementioned example, the electronic medical records having information indicating that an antibiotic is administered are filtered out and thus the electronic medical records of the pneumonia patient can be excluded from the search object.

### Second Embodiment

Now, a second embodiment of the electronic medical record search support system according to the present invention will be described.

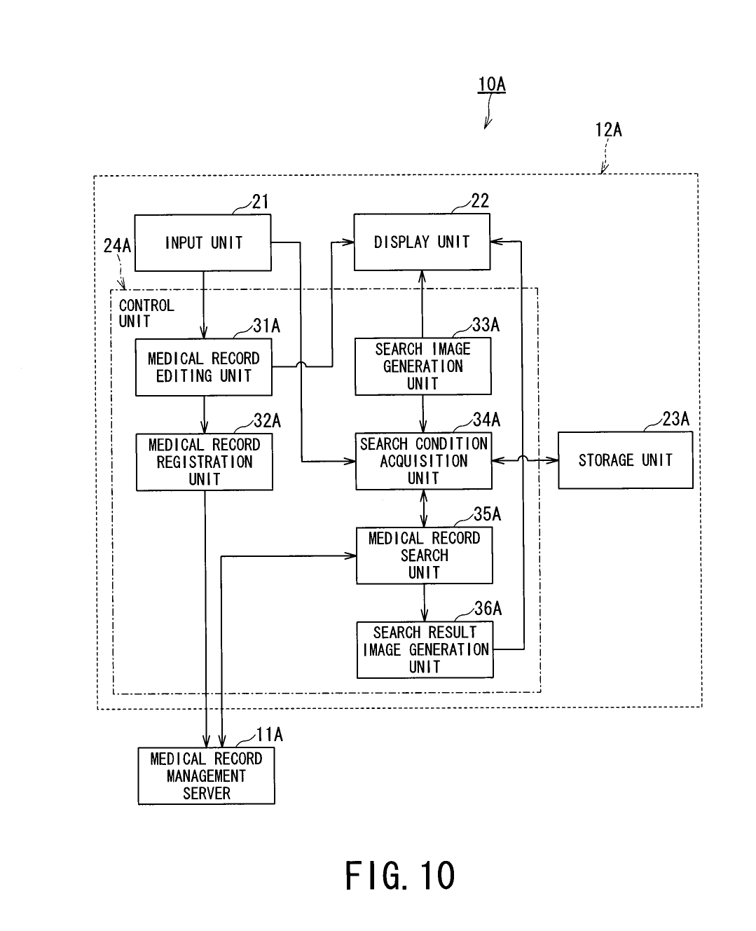

FIG. 10 is an entire configuration view illustrating an example of an electronic medical record search support system 10A according to the second embodiment of the present invention. The electronic medical record search support system 10A according to the second embodiment performs an electronic medical record search and retrieval based on information of at least a region of interest. Note that the same reference numerals or characters are assigned to substantially the same components as those of the electronic medical record search support system 10 illustrated in FIG. 1, and the description thereof is omitted.

First, a configuration related to an electronic medical record registration according to the second embodiment will be described.

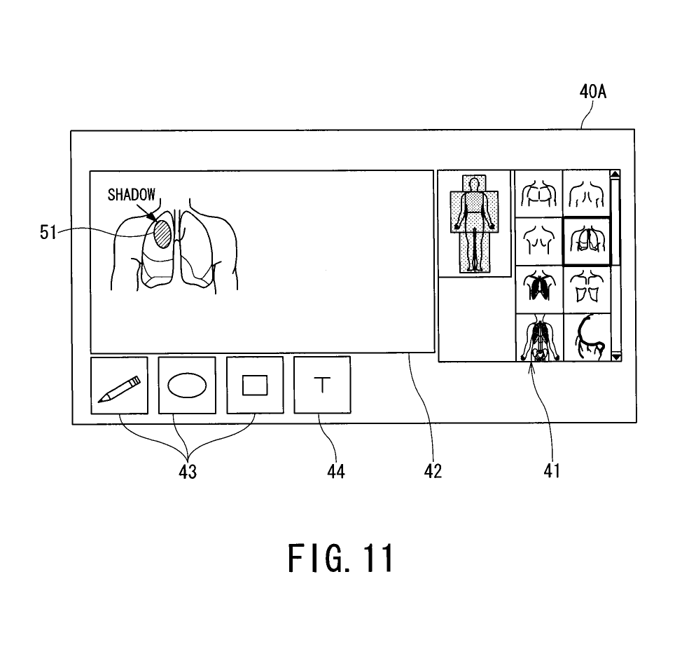

FIG. 11 is an explanatory drawing illustrating an example of an electronic medical record image 40A according to the second embodiment.

When a request to edit a predetermined electronic medical record is received from a user through the input unit 21, the medical record editing unit 31A displays an electronic medical record image 40A whose content is information of the electronic medical record on the display unit 22.

Like the electronic medical record image 40 according to the first embodiment, the electronic medical record image 40A includes the first region 41 and the second region 42 as well as the drawing tool 43 and the text input tool 44.

Like the medical record editing unit 31 according to the first embodiment, the medical record editing unit 31A receives a selection of a schema template as well as a text information input to the electronic medical record (see “shadow” in FIG. 11). Note that in the present embodiment, text information may not be inputted to the electronic medical record.

The medical record editing unit 31A receives a setting of a region of interest (hereinafter referred to as a set region of interest) 51 to a schema template image displayed in the second region 42 using the drawing tool 43.

The medical record registration unit 32A acquires, from the medical record editing unit 31A, information of at least an electronic medical record currently subject to editing, information of a schema template included in the electronic medical record, and information of the set region of interest 51 included in the electronic medical record. Then, when an instruction to register (save) the electronic medical record is received from the user through the input unit 21, the medical record registration unit 32A registers, in the medical record management server 11A, information of at least the electronic medical record, information of the schema template included in the electronic medical record, and information of the set region of interest 51 associated with each other.

As a result, the medical record management server 11A maintains a database associating information of at least the electronic medical record, information of the schema template included in the electronic medical record, and information of the set region of interest 51 with each other. It is obvious that when the user inputs only the information of the schema template as the search condition, the electronic medical record search and retrieval is performed based on only the information of the schema template. As described in the present embodiment, the search using information of the set region of interest 51 makes it easier to increase the accuracy of the search results than the search based on only the information of the schema template.

Secondly, a configuration related to an electronic medical record search and retrieval according to the second embodiment will be described.

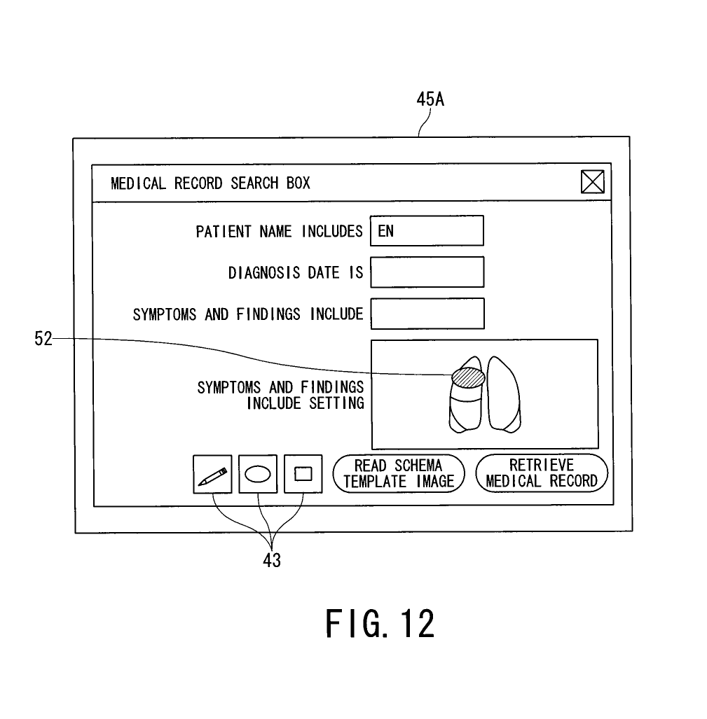

FIG. 12 is an explanatory drawing illustrating an example of an electronic medical record search image 45A according to the second embodiment.

When a search start request of an electronic medical record is received from a user through the input unit 21, the search image generation unit 33A displays a search condition setting image (search image) 45A for receiving an input of electronic medical record search conditions on the display unit 22 (see FIG. 12). The user uses the search image 45A to input search conditions through the input unit 21.

The present embodiment will describe an example in which a search condition inputted by the user is at least a region of interest to be searched for (hereinafter referred to as a region of interest for searching) 52. Note that in the present embodiment, a keyword (character string) in the keyword schema association table need not be a search condition.

For example, in order to set the region of interest for searching 52 as search conditions, the user presses a “read schema template image” key in FIG. 12 to make a request to read a schema template image. When a schema template image reading request is received, the search image generation unit 33A generates a list of images of a plurality of schema templates to be displayed on the display unit 22. The list of images may include the similar images as the schema template calling images in the first region 41 of the electronic medical record images 40 and 40A.

When the user selects a desired schema template from the list of images (for example, the similar image as the schema template calling image in FIGS. 4 and 11), the search image generation unit 33A displays the image of the selected schema template superimposed on the search image 45A on the display unit. FIG. 12 illustrates an example in which the user selects the lung template and an image of the lung template is superimposed on the search image 45A. Then, the user uses the drawing tool 43 to set the region of interest for searching 52 to the image of the schema template. The image of the schema template superimposed on the search image 45A may be a so-called volume rendering image that can be rotated according to the user operation.

Note that the keyword schema association table is stored in the storage unit 23A, and when a keyword is inputted to the symptoms and findings, the image of the schema template associated with the keyword may be automatically selected and displayed in the search image 45A.

The search condition acquisition unit 34A acquires information of a keyword (input keyword) inputted by the user. Note that in the present embodiment, the input keyword need not be a keyword in the keyword schema association table, but may be a keyword such as indicating a patient name and a diagnosis date. In addition, the search condition acquisition unit 34A acquires information of the region of interest for searching 52 and information of the schema template used to set the region of interest for searching 52.

The medical record search unit 35A searches the medical record management server 11A based on information of at least the region of interest for searching 52 acquired by the search condition acquisition unit 34A and information of the schema template used to set the region of interest for searching 52. The following description will focus on an example in which the medical record search unit 35A searches the medical record management server 11A based on information of the input keyword, information of the region of interest for searching 52, and information of the schema template used to set the region of interest for searching 52. Note that the medical record search unit 35A may perform an OR search or an AND search using each search condition.

The search method using the region of interest for searching 52 includes a method in which of the set region of interest 51 for the electronic medical record registered in the medical record management server 11A, a region partially overlapped with the region of interest for searching 52, a region overlapped in a ratio equal to or greater than a predetermined ratio, a region not overlapped but located in the vicinity thereof are extracted by coordinate comparison and image analysis to retrieve an electronic medical record associated with the extracted set region of interest 51.

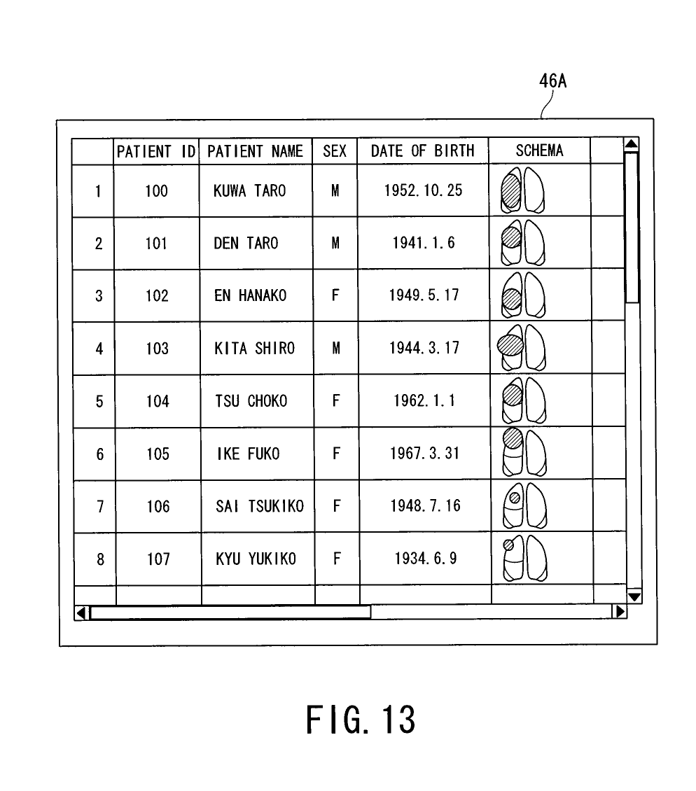

FIG. 13 is an explanatory drawing illustrating an example of an electronic medical record search result image 46A according to the second embodiment.

The search result image generation unit 36A generates a search result image 46A based on the search results of the medical record search unit 35A to be displayed on the display unit 22 (see FIG. 13).

The storage unit 23A preliminarily stores the schema template table (see FIG. 2). Note that the storage unit 23A according to the second embodiment may not store the keyword schema association table.

Now, an example of operation of the electronic medical record search support system 10A according to the second embodiment will be described.

First, an electronic medical record registration process according to the second embodiment will be described.

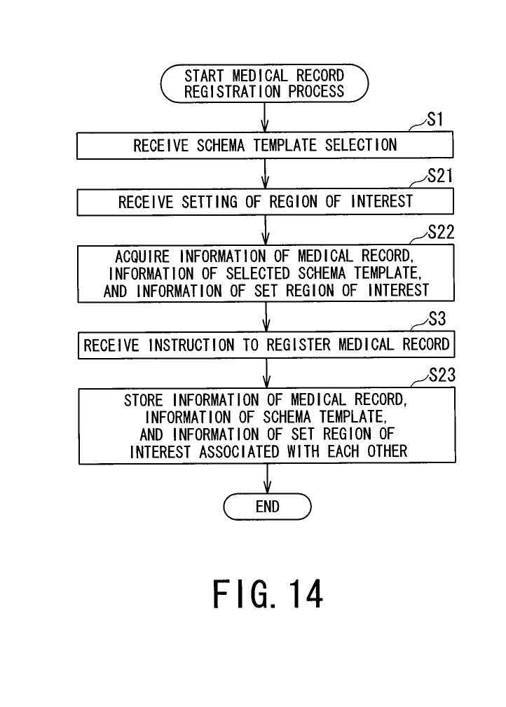

FIG. 14 is a flowchart illustrating a procedure for registering data associating information of at least an electronic medical record, information of a schema template included in the electronic medical record, and information of set region of interest 51 with each other in the medical record management server 11A by means of the CPU of the control unit 24A according to the second embodiment. In FIG. 14, a reference character with “S” followed by a number such as “S1” denotes each step of the flowchart. Note that the same reference numerals or characters are assigned to the same steps as those in FIG. 8, and the duplicate description thereof is omitted.

The procedure starts at a time when a request to edit a predetermined electronic medical record is received from a user through the input unit 21 and an electronic medical record image 40A whose content is information of the electronic medical record is displayed on the display unit 22.

In step S21, the medical record editing unit 31A receives a setting of the set region of interest 51 to a schema template image displayed in the second region 42 using the drawing tool 43.

Then in step S22, the medical record registration unit 32A acquires, from the medical record editing unit 31A, information of at least an electronic medical record currently subject to editing, information of the selected schema template included in the electronic medical record, and information of the set region of interest 51 included in the electronic medical record.

In step S3, the medical record registration unit 32A receives an instruction to register (save) the electronic medical record, and then in step S23, the medical record registration unit 32A registers, in the medical record management server 11A, information of at least the electronic medical record, information of the schema template included in the electronic medical record, and information of the set region of interest 51 associated with each other.

The aforementioned procedure makes it possible to register, in the medical record management server 11A, data associating information of at least the electronic medical record, information of the schema template included in the electronic medical record, and information of the set region of interest 51 with each other.

Now, an operation of an electronic medical record search and retrieval according to the second embodiment will be described.

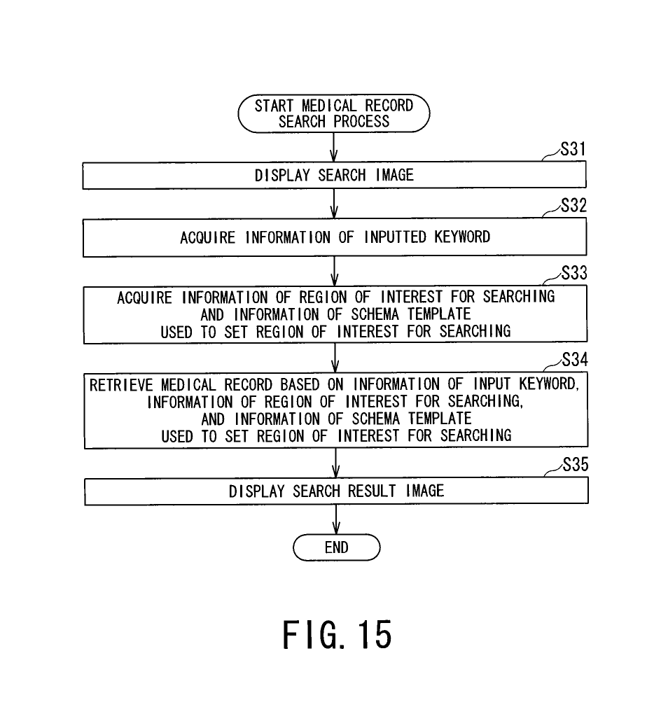

FIG. 15 is a flowchart illustrating a procedure for retrieving the electronic medical record based on the region of interest of the schema template by means of the CPU of the control unit 24A according to the second embodiment. In FIG. 15, a reference character with “S” followed by a number such as “S31” denotes each step of the flowchart.

In step S31, the search image generation unit 33A displays a search image 45A for receiving an input of a search condition for the electronic medical record on the display unit 22 (see FIG. 12). The search condition includes at least the region of interest for searching 52.

Then in step S32, the search condition acquisition unit 34A acquires information of a keyword (input keyword) inputted by the user. The input keyword need not be a keyword in the keyword schema association table but may be a keyword indicating a patient name, a diagnosis date and others.

Then in step S33, the search condition acquisition unit 34A acquires information of the region of interest for searching 52 and information of the schema template used to set the region of interest for searching 52.

Then in step S34, the medical record search unit 35A searches the medical record management server 11A based on information of at least the region of interest for searching 52 acquired by the search condition acquisition unit 34A and information of the schema template used to set the region of interest for searching 52. At the same time, the medical record search unit 35A may also search based on information of the input keyword. Note that the input keyword need not be a keyword in the keyword schema association table.

Then in step S35, the search result image generation unit 36B generates a search result image 46A based on the search results of the medical record search unit 35A to be displayed on the display unit 22 (see FIG. 13).

The aforementioned procedure makes it possible to retrieve the electronic medical record based on the region of interest of the schema template.

The electronic medical record search support system 10A according to the second embodiment uses the set region of interest 51 and the region of interest for searching 52 for search, and thereby can support the user in retrieving a desired electronic medical record even if the text information registered in the electronic medical record varies in expression or the text information is not registered in the electronic medical record. Note that the present embodiment may also use a predetermined exclusion criterion to narrow the search results.

### Third Embodiment

Now, a third embodiment of the electronic medical record search support system according to the present invention will be described.

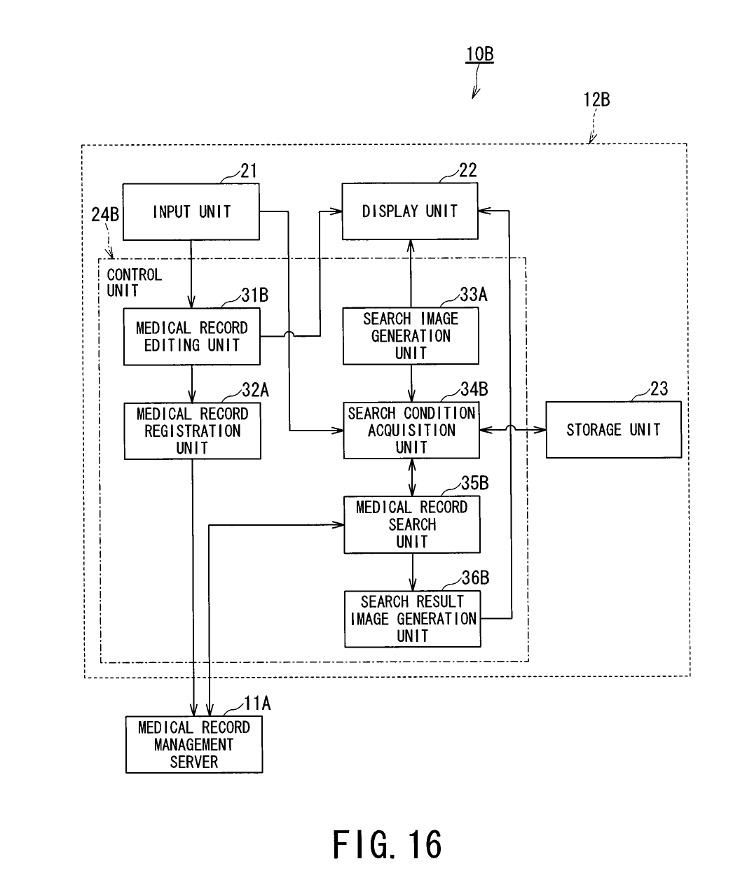

FIG. 16 is an entire configuration view illustrating an example of an electronic medical record search support system 10B according to the third embodiment of the present invention. The electronic medical record search support system 10B according to the third embodiment combines the electronic medical record search support system 10 according to the first embodiment and the electronic medical record search support system 10A according to the second embodiment. The electronic medical record search support system 10B uses information of the schema template associated with a search input keyword and information of the region of interest to retrieve an electronic medical record. Note that the same reference numerals or characters are assigned to substantially the same components as those of the electronic medical record search support system 10 illustrated in FIG. 1, and the description thereof is omitted.

First, a configuration related to an electronic medical record registration according to the third embodiment will be described.

When a request to edit a predetermined electronic medical record is received from a user through the input unit 21, the medical record editing unit 31B displays an electronic medical record image 40A whose content is information of the electronic medical record on the display unit 22.

The medical record editing unit 31B receives a selection of a schema template as well as a text information input to the electronic medical record (see “shadow” in FIG. 11). Note that in the present embodiment, text information may not be inputted to the electronic medical record.

The medical record editing unit 31B receives a setting of the set region of interest 51 to a schema template image displayed in the second region 42. As a result, the electronic medical record includes information of the selected schema template and information of the set region of interest 51.

As described in the second embodiment, the medical record registration unit 32A registers, in the medical record management server 11A, information of at least the electronic medical record, information of the schema template included in the electronic medical record, and information of the set region of interest 51 associated with each other.

As a result, as described in the second embodiment, the medical record management server 11A maintains a database associating information of at least the electronic medical record, information of the schema template included in the electronic medical record, and information of the set region of interest 51 with each other.

Secondly, a configuration related to an electronic medical record search and retrieval according to the third embodiment will be described.

As described in the second embodiment, the search image generation unit 33A displays the search image 45A for receiving an input of electronic medical record search conditions on the display unit 22 (see FIG. 12).

In the third embodiment, the search conditions inputted by the user are a keyword (character string) in the keyword schema association table stored in the storage unit 23 having the same configuration as that of the first embodiment and the region of interest for searching 52.

The search condition acquisition unit 34B acquires information of the keyword (input keyword) inputted by the user and acquires information of the schema template associated with the input keyword from the keyword schema association table (see FIG. 3) in the storage unit 23. For example, if the input keyword is “lung cancer”, the search condition acquisition unit 34B acquires “lung template 1” in the schema template name as illustrated in FIG. 3.

In addition, the search condition acquisition unit 34B acquires information of the region of interest for searching 52. Note that in the present embodiment, the search condition acquisition unit 34B may not acquire information of the schema template used to set the region of interest for searching 52.

Note that when the search condition acquisition unit 34B acquires information of the schema template used to set the region of interest for searching 52, the information of the schema template used to set the region of interest for searching 52 may be different from the information of the schema template acquired from the keyword schema association table. In this case, an OR search may be performed on both information; or an image for prompting the user to select either information to be set as the search condition may be displayed to the user, and either one of the information may be used as the search condition according to the selection by the user.

The following description will focus on an example of using the information of the schema template associated with the search input keyword in the keyword schema association table as the search condition.

The medical record search unit 35B searches the medical record management server 11A based on information of at least the schema template associated with the search input keyword acquired by the search condition acquisition unit 34B and information of the region of interest for searching 52.

The following description will focus on an example in which the medical record search unit 35B searches the medical record management server 11A based on information of the input keyword, information of the schema template associated with the search input keyword, and information of the region of interest for searching 52. Note that the medical record search unit 35B may perform an OR search or an AND search using each search condition.

The search result image generation unit 36B generates a search result image based on the search results of the medical record search unit 35B to be displayed on the display unit 22.

Now, an example of operation of the electronic medical record search support system 10B according to the third embodiment will be described. Note that the electronic medical record registration process according to the third embodiment is the same as the electronic medical record registration process according to the second embodiment as illustrated in FIG. 14, and thus the description thereof is omitted.

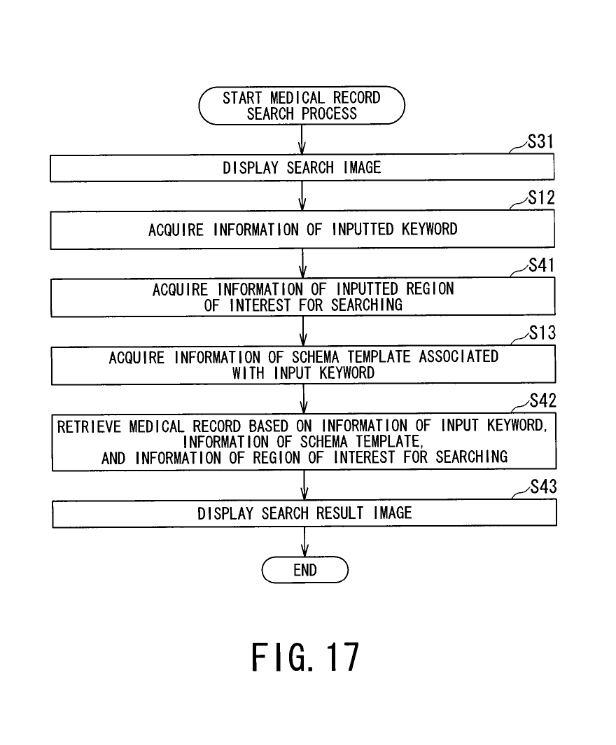

FIG. 17 is a flowchart illustrating a procedure for retrieving an electronic medical record based on information of the schema template used in the electronic medical record and information of the region of interest of the schema template by means of the CPU of the control unit 24B according to the third embodiment. In FIG. 17, a reference character with “S” followed by a number such as “S31” denotes each step of the flowchart. Note that the same reference numerals or characters are assigned to the same steps as those in FIGS. 8 and 14, and the duplicate description thereof is omitted.

In step S41, the search condition acquisition unit 34B acquires information of the region of interest for searching 52.

In step S42, the medical record search unit 35B searches the medical record management server 11A based on information of at least the schema template associated with the search input keyword acquired by the search condition acquisition unit 34B and information of the region of interest for searching 52. At the same time, the medical record search unit 35B may also search based on information of the input keyword.

Then in step S43, the search result image generation unit 36B generates a search result image based on the search results of the medical record search unit 35B to be displayed on the display unit 22.

The aforementioned procedure makes it possible to retrieve the electronic medical record based on information of the schema template used in the electronic medical record and information of the region of interest of the schema template.

The electronic medical record search support system 10B according to the third embodiment uses information of the schema template used in the electronic medical record, the set region of interest 51, and the region of interest for searching 52 for search, and thereby can support the user in retrieving a desired electronic medical record even if the text information registered in the electronic medical record varies in expression or the text information is not registered in the electronic medical record. Note that the present embodiment may also use a predetermined exclusion criterion to narrow the search results.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Moreover, though the embodiment of the invention discloses an example of processing where the steps in the flowchart are carried out in time series in the described order, the steps of the processing need not necessarily carried out in time series and can be executed in parallel or individually.

What is claimed is:

1. A medical information search apparatus comprising:
a registration unit configured to register, in a management server, at least medical information and information of a schema template included in the medical information associated with each other;
a search condition acquisition unit configured to acquire information of the schema template based on a search condition set by a user through an input unit; and
a search unit configured to retrieve, from the management server, medical information associated with information of the schema template acquired by the search condition acquisition unit.

2. The medical information search apparatus according to claim 1, further comprising
a search image generation unit configured to generate a search condition setting image for receiving an input of the search condition to be displayed on a display unit, and configured to superimpose an image of the schema template on the search condition setting image according to a user instruction through the input unit to be displayed on the display unit, wherein
the search condition acquisition unit acquires information of the schema template superimposed on the search condition setting image.

3. The medical information search apparatus according to claim 2, wherein
the search image generation unit generates a list of images of a plurality of schema templates according to a user instruction through the input unit to be displayed on the display unit, and superimposes the image of a schema template selected from the list of images by the user on the search condition setting image to be displayed on the display unit.

4. The medical information search apparatus according to claim 2, wherein
the registration unit registers, in the management server, the medical information further associated with information of a region of interest set to the schema template of the medical information;
the search condition acquisition unit acquires information of a region of interest for searching set by the user through the input unit for the image of the schema template superimposed on the search condition setting image and information of the schema template used to set the region of interest for searching; and
the search unit searches the management server based on the information of the region of interest for searching acquired by the search condition acquisition unit and information of the schema template, and retrieves medical information associated with information of the schema template acquired by the search condition acquisition unit and associated with a region of interest overlapped with the region of interest for searching in a ratio equal to or greater than a predetermined ratio.

5. The medical information search apparatus according to claim 1, further comprising
a storage unit configured to store information of the schema template and a keyword associated with each other, wherein
the search condition acquisition unit acquires information of a keyword set by the user through the input unit and acquires information of the schema template associated with the keyword from the storage unit.

6. The medical information search apparatus according to claim 5, wherein the keyword includes at least one of an organ name and a disease name.

7. The medical information search apparatus according to claim 5, wherein
the registration unit registers, in the management server, the medical information further associated with text information recorded in the medical information; and
the search unit retrieves, from the management server, the medical information further associated with the text information corresponding to the keyword acquired by the search condition acquisition unit.

8. The medical information search apparatus according to claim 7, wherein
the search unit searches the management server based on the keyword acquired by the search condition acquisition unit and the information of the schema template, and retrieves the medical information associated with both of the text information corresponding to the keyword acquired by the search condition acquisition unit and the information of the schema template.

9. The medical information search apparatus according to claim 5, wherein
the storage unit preliminarily stores the keyword, the information of the schema template, and a predetermined exclusion criterion associated with each other;
the search condition acquisition unit acquires information of the keyword set by the user through the input unit and acquires the information of the schema template associated with the keyword and the predetermined exclusion criterion from the storage unit; and
the search unit searches the management server by excluding the medical information associated with the predetermined exclusion criterion from the search object.

10. The medical information search apparatus according to claim 5, further comprising
a search image generation unit configured to generate a search condition setting image for receiving an input of the search condition to be displayed on a display unit and configured to superimpose an image of the schema template on the search condition setting image according to a user instruction through the input unit to be displayed on the display unit, wherein
the search condition acquisition unit acquires information of the schema template superimposed on the search condition setting image.

11. The medical information search apparatus according to claim 10, wherein
the search image generation unit generates a list of images of a plurality of schema templates according to a user instruction through the input unit to be displayed on the display unit, and superimposes an image of a schema template selected from the list of images by the user on the search condition setting image to be displayed on the display unit.

12. The medical information search apparatus according to claim 10, wherein
the registration unit registers, in the management server, the medical information further associated with information of a region of interest set to the schema template of the medical information;
the search condition acquisition unit acquires information of a region of interest for searching set by the user through the input unit for the image of the schema template superimposed on the search condition setting image and information of the schema template used to set the region of interest for searching; and
the search unit searches the management server based on the information of the region of interest for searching acquired by the search condition acquisition unit and information of the schema template, and retrieves medical information associated with information of the schema template acquired by the search condition acquisition unit and associated with a region of interest overlapped with the region of interest for searching in a ratio equal to or greater than a predetermined ratio.

13. The medical information search apparatus according to claim 1, further comprising
a search result image generation unit configured to generate an image whose content is the medical information retrieved from the management server by the search unit to be displayed on a display unit.

14. The medical information search apparatus according to claim 2, wherein
the image of the schema template is a volume rendering image; and
the search image generation unit rotates the image of the schema template displayed on the display unit in response to a user input.

15. The medical information search apparatus according to claim 1, wherein
the medical information is an electronic medical record.
